(19) United States
(12) Patent Application Publication
(10) Pub. No.: US 2026/0283400 A1
(43) Pub. Date: Sep. 24, 2026

(54) SPRING-BIASED FOOD HEATING APPARATUS

(71) Applicant: STEARNS PRODUCT DEVELOPMENT CORPORATION, Perris, CA (US)

(72) Inventor: Howard J. Frantz, Irvine, CA (US)

(21) Appl. No.: 19/570,934

(22) Filed: Mar. 18, 2026

Related U.S. Application Data
(60) Provisional application No. 63/776,098, filed on Mar. 22, 2025.

(51) Int. Cl. A47J 37/06; A23L 5/10; A47J 36/12

(52) U.S. Cl. CPC A47J 37/0611; A23L 5/15; A47J 36/12

(57) ABSTRACT

A food heating apparatus includes a lower heated platen and an upper heated platen movable relative to the lower heated platen between a raised position and a lowered position. A hinge assembly couples the upper heated platen to the lower heated platen, and a spring or other biasing mechanism biases the upper heated platen toward the raised position. The upper heated platen is manually movable to the lowered position by a user and automatically returns toward the raised position when the manual force is released.

### CROSS-REFERENCE TO RELATED APPLICATIONS

This application claims the benefit of U.S. Provisional Application Ser. No. 63/776,098, filed Mar. 22, 2025, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to food heating apparatuses and, more particularly, to clamshell and griddle-based apparatuses having an upper heated platen biased toward a raised position.

### 2. Description of the Related Art

Heated food preparation equipment is commonly used to warm tortillas and other bread-based food products prior to serving. In many commercial and food-service settings, it is desirable to heat a tortilla quickly while maintaining the tortilla in a hot, pliable condition suitable for subsequent filling, folding, or serving.

Some conventional tortilla warming devices employ opposed heated surfaces in a clamshell arrangement. In such arrangements, a food product may be positioned on a lower heated surface and an upper heated surface may be lowered onto the food product for heating from both sides. However, in some conventional configurations, the upper heated surface may remain in a closed position until it is affirmatively lifted by an operator. As a result, the food product may remain between the heated surfaces longer than intended if the operator is distracted or delayed. This can lead to excessive dwell time, inconsistent heating, scorching, or other undesirable changes in the condition of the food product.

In some food-service environments, rapid preparation is desirable, and there may be advantages to operating heated surfaces at relatively elevated temperatures so that warming can occur in a short interval. However, as platen temperature increases, control over dwell time may become more significant. Accordingly, a need remains for heating equipment that provides fast and effective warming while reducing the likelihood that a tortilla or other food product will remain in contact with heated surfaces for an excessive period of time.

Various aspects of the present disclosure address this particular need, as will be discussed in more detail below.

### BRIEF SUMMARY

In accordance with one embodiment of the present disclosure, a food heating apparatus includes a lower clamshell having a lower base and a lower heated platen, and an upper clamshell having an upper base and an upper heated platen. The upper clamshell is movably coupled to the lower clamshell by a hinge assembly such that the upper heated platen is movable relative to the lower heated platen between a raised position and a lowered position. A biasing mechanism acts between the upper clamshell and the lower clamshell so as to bias the upper clamshell, and thus the upper heated platen, toward the raised position.

The biasing mechanism may be configured such that the upper clamshell does not remain in the lowered position on its own, but instead remains lowered only while an operator applies a manual downward holding force. As a result, the upper heated platen may be manually lowered against the force of the biasing mechanism to heat a food product positioned on the lower heated platen and may automatically return upwardly when the manual force is reduced or released. In some embodiments, the biasing mechanism may provide an active lifting function rather than merely counterbalancing the weight of the upper clamshell.

In some embodiments, the disclosed arrangement provides an attended press-and-release mode of operation. For example, an operator may place a tortilla or other food product on the lower heated platen, manually lower the upper heated platen, hold the upper heated platen in the lowered position for a brief heating interval, and then release the upper clamshell such that the upper heated platen automatically rises. Because the upper clamshell is biased upwardly, the operator may remain physically engaged with the apparatus during substantially the entire heating interval rather than lowering the upper heated platen and turning attention to another task while the food product remains between the heated platens.

According to various implementations, this normally raised configuration may reduce the likelihood that a tortilla or other food product remains between the heated platens longer than intended due to distraction, interruption, or delay. The attended press-and-hold operation may permit relatively short dwell times, such as about 1 to 2 seconds in some implementations, and may permit a rapid overall heating cycle, such as about 3 to 4 seconds in some implementations. In some embodiments, the disclosed configuration may also permit operation at relatively higher platen temperatures while still reducing the likelihood of overheating associated with excessive dwell time.

The biasing mechanism may include one or more springs, such as one or more tension springs, operatively associated with the hinge assembly. In other embodiments, the biasing mechanism may include a hydraulic piston, a gas spring, a torsion member, a resilient member, or another mechanism capable of urging the upper clamshell toward the raised position. The biasing mechanism may be arranged generally along a hinge axis, adjacent side portions of the apparatus, or at another suitable location, and may be selected so that the upper clamshell rises in a controlled manner when released.

According to further aspects of the disclosed subject matter, an upper heated platen may be biased above a lower griddle surface of a griddle body. In such embodiments, the upper heated platen may be manually lowered against a biasing force to press a food product against the lower griddle surface and may automatically return upwardly when released. The upper heated platen may be provided as part of a conversion kit for an existing griddle or may be incorporated into the griddle as originally manufactured. Accordingly, the disclosed subject matter encompasses both clamshell-type heating apparatuses and griddle-based heating apparatuses employing a normally raised upper heated platen and an attended press-and-release heating operation.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a clamshell food heating apparatus according to one embodiment, showing an upper heated platen in a raised position above a lower heated platen and a biasing mechanism arranged along a rear region of the apparatus;

FIG. 2 is a perspective view of a clamshell food heating apparatus according to another embodiment, showing an upper heated platen in a raised position above a lower heated platen and a biasing mechanism arranged adjacent side portions of the apparatus; and

FIG. 3 is a perspective view of an alternative food heating apparatus in which an upper heated platen is biased above a lower griddle surface of a griddle body.

Common reference numerals are used throughout the drawings and the detailed description to indicate the same elements.

### DETAILED DESCRIPTION

The detailed description set forth below in connection with the appended drawings is intended as a description of certain embodiments of a tortilla toaster and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

According to various aspects of the present disclosure, there is provided a food heating apparatus in the form of a clamshell-type heating device having an upper heated platen and a lower heated platen. The upper heated platen is biased toward a raised position relative to the lower platen, which is a departure from conventional heating devices which are configured to remain closed until affirmatively reopened by an operator. As a result, the upper heated platen may be lowered only while manual force is applied by the operator and may automatically return upwardly when the manual force is released. This normally raised arrangement may provide a press-and-release mode of operation in which a food product is contacted between opposed heated surfaces for a controlled and relatively short dwell interval.

The normally raised upper heated platen may reduce the likelihood that a tortilla or other food product remains between heated surfaces longer than intended due to operator distraction or delay. Because the heating interval may be intentionally brief, the apparatus may be operated at relatively higher platen temperatures while still avoiding overheating that can occur in arrangements in which the upper platen remains closed after release. The disclosed configuration may thereby provide rapid heating while maintaining a desired food condition, such as a hot and pliable tortilla suitable for subsequent handling, folding, or serving.

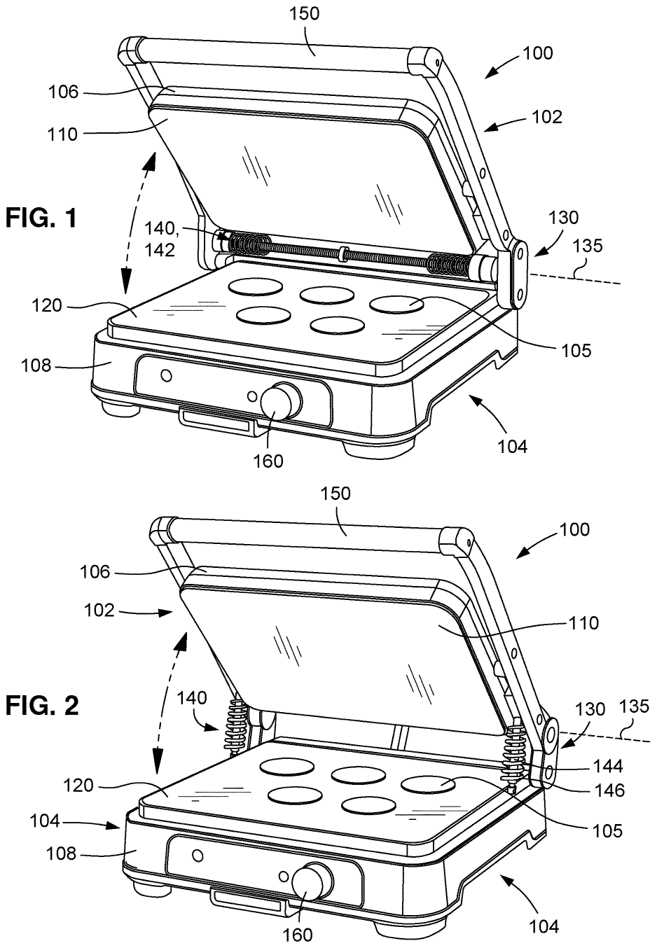

Referring now to the drawings, wherein the showings are for purposes of illustrating illustrative embodiments of the disclosed subject matter and not for purposes of limiting the same, FIGS. 1 and 2 illustrate a clamshell food heating apparatus 100 configured for rapid heating of tortillas 105 and other food products. In some embodiments, the apparatus 100 may generally include an upper clamshell 102 and a lower clamshell 104 movably coupled to one another. The upper clamshell 102 may include an upper base 106 and an upper heated platen 110 carried by, mounted to, or otherwise coupled to the upper base 106. The lower clamshell 104 may include a lower base 108 and a lower heated platen 120 carried by, mounted to, or otherwise coupled to the lower base 108. In some embodiments, the upper base 106 and the lower base 108 may provide structural support for the respective heated platens and associated components of the apparatus 100.

The upper clamshell 102 may be movably coupled to the lower clamshell 104 by a hinge assembly 130 located generally toward a rear portion of the apparatus 100. The hinge assembly 130 may permit the upper clamshell 102, including the upper base 106 and upper heated platen 110, to pivot relative to the lower clamshell 104, including the lower base 108 and lower heated platen 120, between a raised position and a lowered position. A spring or other biasing mechanism 140 may be associated with the hinge assembly 130 and may act between the upper clamshell 102 and the lower clamshell 104 so as to bias the upper clamshell 102, and thus the upper heated platen 110, toward the raised position. The apparatus 100 may further include a handle 150 coupled to the upper clamshell 102, such as to the upper base 106 or to an upper portion of the upper heated platen 110, to facilitate manual movement of the upper clamshell 102 toward the lowered position. One or more controls, such as a control knob 160, may be provided on the lower base 108 to enable selective heat control of the upper heated platen 110 and/or lower heated plate 120. The handle 150 and related support arm may be coupled to the upper base 106 in a manner that allows the upper heated platen 110 to self-level slightly when lowered onto the food product. If such self-leveling were not integrated into the attachment of the handle/support arm attachment to the upper base 106, more pressure may be applied to food products positioned towards the back of the lower platen 120 than those positioned toward the front of the lower platen 120.

The upper heated platen 110 is movable relative to the lower heated platen 120 between the raised position and the lowered position by movement of the upper clamshell 102 relative to the lower clamshell 104. In the raised position, the upper heated platen 110 is spaced above the lower heated platen 120 to permit placement or removal of a food product. In the lowered position, the upper heated platen 110 is brought into proximity with the lower heated platen 120 so that a food product, such as a tortilla, positioned therebetween may be heated from both sides. In some embodiments, the upper clamshell 102 is normally biased upwardly such that the upper heated platen 110 remains in the raised position unless an operator applies a manual downward force to the handle 150 or directly to the upper clamshell 102.

According to one embodiment, the biasing mechanism 140 is configured not merely to counterbalance the weight of the upper clamshell 102, but to actively urge the upper clamshell 102 upwardly to the raised position whenever the operator is not applying a downward holding force. Stated differently, the upper clamshell 102 may be configured so that it does not remain in the lowered position on its own. Rather, the upper clamshell 102 may remain lowered only while the operator continues to apply manual force, and may begin to return upwardly once that manual force is reduced or removed. This normally raised arrangement may distinguish the apparatus 100 from clamshell heating devices in which a spring arrangement merely offsets weight while still permitting the upper platen to remain where placed.

The biasing mechanism 140 may include one or more springs located in, adjacent to, or otherwise operatively associated with the hinge assembly 130. The one or more springs may act between the upper clamshell 102 and the lower clamshell 104 so as to generate an upward return force on the upper clamshell 102 throughout at least a portion of its travel between the lowered position and the raised position. The biasing mechanism 140 may be selected, positioned, and adjusted so that the operator can lower the upper clamshell 102 with a relatively small manual force while the upper clamshell 102 nevertheless automatically returns upwardly when released. The biasing mechanism 140 may therefore be tuned to provide a lifting function rather than solely a neutral balancing function.

The upward bias may be set such that the upper clamshell 102 rises in a controlled manner when released, rather than abruptly snapping upward. For example, the spring force may be sufficient to return the upper heated platen 110 to an open, ready position, but not so great as to make downward movement difficult or to create an uncontrolled opening action. This controlled upward return may improve ease of operation during repeated heating cycles and may permit the operator to perform a quick press-and-release motion with predictable movement of the upper heated platen 110.

In some embodiments, the upward bias applied by the biasing mechanism 140 is sufficient such that the upper clamshell 102 does not remain in the lowered position unless the operator continuously applies a downward holding force. As a result, the heating operation may be performed as an attended manual step in which the operator lowers and holds the upper heated platen 110 against the food product for the intended heating interval and then releases the upper clamshell 102. The operator therefore remains physically engaged with the apparatus 100 during the heating interval rather than lowering the upper heated platen 110 and turning attention to another task while the food product remains between the heated platens.

This operational characteristic may be particularly beneficial where the intended heating interval is short, such as about 1 to 2 seconds in some tortilla-heating implementations. Because the upper clamshell 102 is biased upwardly and automatically rises upon release, the apparatus 100 may be configured so that the operator maintains attention on the tortilla or other food product throughout substantially the entire pressing interval. This may reduce the likelihood that the food product will be left between the heated platens longer than intended due to distraction, interruption, or the operator beginning another task before the heating cycle is complete. Along those lines, certain conventional devices may include a lock, such as a physical latch or electromagnet, that holds the upper clamshell in the downward position, and may be released upwardly at the end of a countdown timer cycle. Such devices tend to be more complicated and costly that the simplified manual hold-down design shown and described herein. In other words, various aspects of the present disclosure are formed without the lock, which may allow for hotter temperatures, shorter dwell time, and more inexpensive manufacturing.

The upwardly biased configuration may also provide an apparatus 100 that is normally in an open, food-receiving state between heating operations. As a result, after a heated food product is released from between the platens, the operator may immediately access the lower heated platen 120 to remove the heated food product and place a subsequent food product on the lower heated platen 120. This may improve workflow efficiency in high-speed food preparation environments while preserving the rapid, short-duration heating associated with the upwardly biased upper clamshell 102.

FIGS. 1 and 2 depict embodiments having generally the same mode of operation. In each embodiment, an operator may place a tortilla or other food product on the lower heated platen 120 and then manually lower the upper clamshell 102 so that the upper heated platen 110 moves downwardly against the force of the biasing mechanism 140. The operator may hold the upper heated platen 110 in the lowered position for a selected dwell time, such as about 1 to 2 seconds in some tortilla-heating implementations, and may then release the upper clamshell 102. Upon release, the biasing mechanism 140 causes the upper clamshell 102 and the upper heated platen 110 to rise automatically toward the raised position. The automatic return of the upper heated platen 110 may reduce the time during which the food product remains compressed between the platens and may facilitate a rapid heating cycle. In some embodiments, the overall heating cycle, including placement, pressing, release, and removal, may be completed in about 3 to 4 seconds.

The normally raised configuration of the upper heated platen 110 can permit operation at a higher platen temperature than would typically be desirable in a clamshell arrangement in which the upper platen remains down until affirmatively reopened by the operator. Because the operator may perform a brief press-and-release action rather than leaving the apparatus closed for an extended interval, the risk of excessive dwell time may be reduced. This arrangement may permit faster heating while maintaining a hot and pliable tortilla. Although tortillas are a principal application, the apparatus 100 may also be used with other food products requiring a brief application of heat, including flatbreads, bagels, and pressed sandwiches.

FIG. 1 illustrates one embodiment in which the biasing mechanism 140 includes a spring 142 arranged generally along a rear region of the apparatus 100 adjacent the hinge assembly 130. In this embodiment, the hinge assembly 130 may include laterally spaced hinge portions defining a hinge axis 135 about which the upper clamshell 102 may pivot relative to the lower clamshell 104 between the raised and lowered positions. The spring 142 may extend generally between the hinge portions so as to act on the upper clamshell 102 through the hinge assembly 130. In some embodiments, the spring 142 may be disposed about the hinge axis 135 and may extend longitudinally along at least a portion of the hinge axis. The handle 150 may be positioned at an upper front region of the upper clamshell 102 to facilitate manual lowering by the operator. The control knob 160 may be positioned on a front portion of the lower base 108 to permit adjustment of heating settings. The embodiment of FIG. 1 may be configured such that the biasing force is sufficient to return the upper heated platen 110 upwardly when released, while still allowing the operator to lower and hold the upper heated platen 110 with a relatively small manual force.

FIG. 2 illustrates another embodiment of the apparatus 100 in which the overall structure and operation may be substantially the same as in FIG. 1, but the biasing mechanism 140 is arranged differently. More particularly, FIG. 2 shows biasing elements (e.g., piston 144 and spring 146 positioned adjacent side portions of the apparatus 100 near the hinge assembly 130. In this regard, the biasing mechanism 140 depicted in FIG. 2 may not extend longitudinally along the hinge axis. Instead, the biasing elements 144, 146 may be spaced from the hinge axis 135, with an upper end portion of the biasing elements 144, 146 attached to or acting on the upper clamshell 102 and a lower end portion of the biasing elements 144, 146 attached to or acting on the lower clamshell 104. Aside from the position and configuration of the biasing mechanism 140, the embodiment of FIG. 2 may operate in the same manner described above with respect to FIG. 1. Thus, the operational description of manually lowering the upper heated platen 110, maintaining the upper heated platen 110 in a lowered position for a selected interval, and releasing the upper heated platen 110 for automatic upward return may apply equally to the embodiments of FIGS. 1 and 2.

The biasing mechanism 140 may be selected and adjusted so that the upper heated platen 110 rises in a controlled manner when released rather than rapidly snapping upward. The amount of bias may be chosen so that the upper heated platen 110 does not remain in the lowered position unless the operator continues to hold it down, while also avoiding a lifting force that would make operation difficult or unsafe. In some implementations, the biasing mechanism 140 may include one or more springs, including tension springs. However, other spring or biasing arrangements may be employed without departing from the scope of the disclosure. Other embodiments may use a hydraulic piston, a gas spring, a torsion member, a resilient member, or another suitable biasing mechanism in place of, or in combination with, one or more springs.

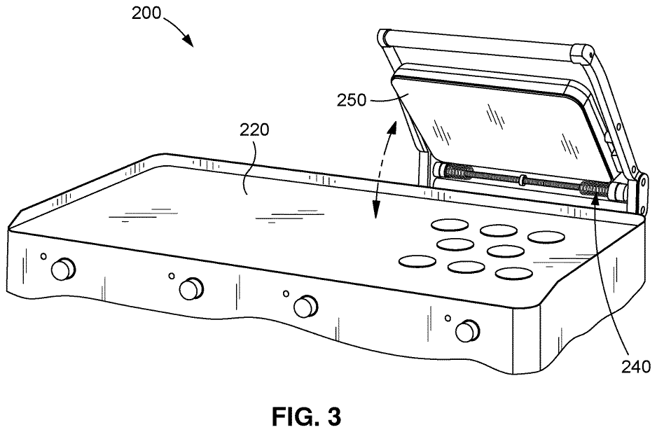

FIG. 3 illustrates an alternative food heating apparatus 200 in which an upper heated platen 250 is biased above a lower griddle surface 220 of a griddle body. The upper heated platen 250 may be part of a conversion kit configured to be added to an existing griddle, or may be provided as a feature originally included with the griddle body. In this embodiment, the lower griddle surface 220 may extend laterally beyond the area directly beneath the upper heated platen 250 so that the apparatus 200 provides both a griddle cooking surface and a localized press-heating region. The apparatus 200 may further include one or more control knobs positioned on a front portion of the griddle body for controlling one or more heating zones. A hinge or support structure may couple the upper heated platen 250 to the griddle body, and a spring or other biasing mechanism 240 may urge the upper heated platen 250 toward a raised position.

According to some implementations, the upper heated platen 250 of FIG. 3 may be mounted to a rear portion of the griddle body. In other embodiments, the upper heated platen 250 may be coupled to a wall, support frame, or other surface adjacent the griddle body such that the upper heated platen 250 is positioned above a selected portion of the lower griddle surface 220. In either arrangement, the upper heated platen 250 may be manually lowered against the force of the biasing mechanism 240 to press a tortilla or other food product against the lower griddle surface 220 and may automatically return upwardly when released. Accordingly, the embodiment of FIG. 3 may provide the same normally raised, press-and-release operation described with respect to FIGS. 1 and 2 while being incorporated into a broader griddle-style cooking platform.

Although particular embodiments are illustrated and described, the disclosed subject matter is not limited to the specific structural arrangements shown in the drawings. The size, shape, and relative placement of the platens, hinge structures, handles, housings, controls, and biasing components may vary. The upper heated platen may be biased by springs disposed within a hinge assembly, adjacent side supports, along a rear support region, or at another suitable location. Likewise, the lower heating surface may be provided as a dedicated lower platen or as a portion of a larger griddle. These and other modifications may be made while retaining the normally raised upper platen configuration in which the upper heated platen is lowered by manual force and automatically rises when the manual force is released.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A clamshell food heating apparatus comprising:
a lower heated platen;
an upper heated platen movable relative to the lower heated platen between a raised position and a lowered position;
a hinge assembly coupling the upper heated platen to the lower heated platen; and
a spring mechanism associated with the hinge assembly and configured to bias the upper heated platen toward the raised position, wherein the upper heated platen is movable to the lowered position by manual force applied by a user and automatically returns toward the raised position when the manual force is released.

2. The clamshell food heating apparatus of claim 1, wherein the spring mechanism comprises one or more tension springs.

3. The clamshell food heating apparatus of claim 1, wherein the spring mechanism is disposed in the hinge assembly.

4. The clamshell food heating apparatus of claim 1, wherein the upper heated platen is normally in the raised position.

5. The clamshell food heating apparatus of claim 1, wherein the upper heated platen remains in the lowered position only while the manual force is maintained.

6. The clamshell food heating apparatus of claim 1, wherein the spring mechanism is configured such that the upper heated platen rises in a controlled fashion when the manual force is released.

7. The clamshell food heating apparatus of claim 1, wherein the clamshell food heating apparatus is configured to heat a tortilla.

8. The clamshell food heating apparatus of claim 7, wherein the clamshell food heating apparatus is configured such that the upper heated platen is manually held in the lowered position for about 1 second to heat the tortilla.

9. The clamshell food heating apparatus of claim 7, wherein the clamshell food heating apparatus is configured to complete a heating cycle in 3 to 4 seconds.

10. The clamshell food heating apparatus of claim 1, wherein the clamshell food heating apparatus is configured to heat a food product selected from the group consisting of a flatbread, a bagel, and a panini sandwich.

11. A tortilla grill comprising:
a lower heated platen;
an upper heated platen movable relative to the lower heated platen;
one or more hinges connecting the upper heated platen to the lower heated platen; and
one or more tension springs disposed in the one or more hinges and configured to raise the upper heated platen to a raised position unless the upper heated platen is physically lowered and held by an operator.

12. The tortilla grill of claim 11, wherein the one or more tension springs are adjusted to gently raise the upper heated platen.

13. The tortilla grill of claim 11, wherein the one or more tension springs are adjusted such that the upper heated platen rises in a controlled fashion when released by the operator.

14. The tortilla grill of claim 11, wherein the tortilla grill is configured to heat a tortilla from both sides when the upper heated platen is in a lowered position.

15. The tortilla grill of claim 11, wherein the tortilla grill is configured for a press-and-release operation in which the operator lowers the upper heated platen, holds the upper heated platen in the lowered position for about 1 second, and then releases the upper heated platen.

16. The tortilla grill of claim 11, wherein the lower heated platen and the upper heated platen are configured to operate at a temperature higher than a temperature used in a clamshell grill having an upper platen that remains in a lowered position after release by the operator.

17. A method of heating a food product with a clamshell food heating apparatus comprising:
placing the food product on a lower heated platen of the clamshell food heating apparatus;
manually moving an upper heated platen of the clamshell food heating apparatus from a raised position to a lowered position against a spring bias;
maintaining the upper heated platen in the lowered position while continuing to apply manual force to the upper heated platen;
releasing the manual force such that the upper heated platen automatically returns toward the raised position; and
removing the food product from the lower heated platen.

18. The method of claim 17, wherein the food product comprises a tortilla.

19. The method of claim 18, wherein maintaining the upper heated platen in the lowered position comprises maintaining the upper heated platen in the lowered position for about second.

20. The method of claim 18, wherein placing the food product, manually moving the upper heated platen, maintaining the upper heated platen in the lowered position, releasing the manual force, and removing the food product are completed in 3 to 4 seconds.
